(19) United States
(12) Patent Application Publication
(10) Pub. No.: US 2023/0051358 A1
(43) Pub. Date: Feb. 16, 2023

(54) POWER TOOL AND ELECTRIC PIPE CUTTER

(71) Applicant: Nanjing Chervon Industry Co., Ltd., Nanjing (CN)

(72) Inventors: Shichun TAO, Nanjing (CN); Lai LIU, Nanjing (CN); Lianghua Ni, Nanjing (CN); Baofeng Fan, Nanjing (CN)

(21) Appl. No.: 17/878,977

(22) Filed: Aug. 2, 2022

(30) Foreign Application Priority Data
Aug. 10, 2021 (CN) 202110912193.8
Aug. 10, 2021 (CN) 202110912202.3

(51) Int. Cl. B23D 21/00; B25F 5/00; B25F 5/02

(52) U.S. Cl. CPC B23D 21/00; B25F 5/001; B25F 5/02; B23D 33/00

(57) ABSTRACT

A power tool includes a casing, a cutting unit, a transmission device, and a toggle switch. The casing includes a support portion. The cutting unit is used for cutting a target object and moving between a first position and a second position relative to the support portion. The toggle switch includes at least a third position and a fourth position. When the toggle switch is at the third position, the cutting unit performs a first motion: the cutting unit moves from the second position to the first position. When the toggle switch is at the fourth position, the cutting unit performs a second motion: the cutting unit moves from the first position to the second position. A speed at which the cutting unit performs the second motion is greater than a speed at which the cutting unit performs the first motion.

### RELATED APPLICATION INFORMATION

This application claims the benefit under 35 U.S.C. § 119(a) of Chinese Patent Application No. CN 202110912202.3, filed on Aug. 10, 2021, and Chinese Patent Application No. CN 202110912193.8, filed on Aug. 10, 2021, which applications are incorporated herein by reference in their entirety.

### BACKGROUND

Pipes include wire pipes, water pipes and the like and are commonly used in homes, engineering and other environments. To satisfy piping requirements at a site, pipes are cut according to usage requirements. Most of the existing pipe cutting devices are manual and cut pipes having relatively high hardness with relatively low efficiency. Due to unreasonable transmission structures and control processes, a small number of electric pipe cutters have problems such as low pipe cutting efficiency, excessive machine sizes, poor portability, and operation complexity.

### SUMMARY

A power tool includes a casing, a cutting unit, a transmission device, and a toggle switch. The casing includes a support portion. The cutting unit is used for cutting a target object and moving between a first position and a second position relative to the support portion under an action of a driving device. The transmission device is used for connecting the driving device to the cutting unit. The toggle switch includes at least a third position and a fourth position. In the case where the toggle switch is at the third position, the cutting unit performs a first motion under the action of the driving device: the cutting unit moves from the second position to the first position. In the case where the toggle switch is at the fourth position, the cutting unit performs a second motion under the action of the driving device: the cutting unit moves from the first position to the second position. A speed at which the cutting unit performs the second motion is greater than a speed at which the cutting unit performs the first motion.

In some examples, the transmission device includes an output shaft, a brake assembly, and an output gear assembly. The brake assembly is connected to the toggle switch. In cases where the toggle switch is at the third position and the fourth position, the brake assembly is at a fifth position and a sixth position, respectively. The output gear assembly is disposed on the output shaft and drivingly connected to the cutting unit. In the case where the brake assembly is at the fifth position, the output gear assembly moves relative to the output shaft; and in the case where the brake assembly is at the sixth position, the output gear assembly moves around the output shaft.

In some examples, the output gear assembly includes an output gear, an end of the output gear is connected to an output internal ring gear, and the brake assembly is provided at another end of the output gear; and the cutting unit is connected to the output internal ring gear and driven by the output internal ring gear to rotate.

In some examples, the output internal ring gear is fan-shaped or semi-circular and rotates around a fixed axis.

In some examples, the brake assembly includes a fixed ring and a ring gear.

The fixed ring is connected to the toggle switch. The ring gear is connected to the fixed ring, where an inner side of the ring gear is drivingly connected to the output shaft. In some examples, the transmission device includes a planetary gearset, where the planetary gearset includes a sun gear and a planet gear. The sun gear is connected to the output shaft. The planet gear meshes with the sun gear, where a planet rotating shaft is provided at the center of the planet gear, an end of the planet rotating shaft is connected to the planet gear, and another end of the planet rotating shaft is connected to an output gear.

In some examples, the sun gear includes a primary sun gear and a secondary sun gear, where in the case where the brake assembly is at the sixth position, the brake assembly is drivingly connected to the secondary sun gear.

In some examples, a steering controller is configured to switch the driving device between forward rotation and reverse rotation according to a state of the power tool or an operation of a user so that the cutting unit performs the first motion or the second motion.

In some examples, a battery pack is included, where an orthographic projection of the battery pack on a plane perpendicular to a front and rear direction is a first projection, an orthographic projection of the casing on the plane perpendicular to the front and rear direction is a second projection, and the first projection is at least partially below the second projection.

In some examples, a main switch is included and configured to control the driving device to be started or stopped, where in the case where the driving device is started, the cutting unit performs the first motion.

In some examples, the toggle switch is automatically reset from the fourth position to the third position.

In some examples, the transmission device or the driving device includes a gear skip mechanism, and after the cutting unit moves to the first position or the second position, the gear skip mechanism causes the driving device or the transmission device to be in a clutch state; or when the cutting unit moves between the first position and the second position, in the case where the cutting unit is overloaded, the gear skip mechanism causes the driving device or the transmission device to be in a clutch state.

A power tool includes a casing, a cutting unit, and a transmission device. The casing includes a support portion. The cutting unit is used for cutting a target object and moving between a first position and a second position relative to the support portion under an action of a driving device. The transmission device is used for drivingly connecting the driving device to the cutting unit. The cutting unit includes a first motion and a second motion, where the first motion is that the cutting unit moves from the second position to the first position under the action of the driving device; and the second motion is that the cutting unit moves from the first position to the second position under the action of the driving device. A speed at which the cutting unit performs the second motion is greater than a speed at which the cutting unit performs the first motion.

An electric pipe cutter includes a motor, a casing, a cutting unit, a main switch, a toggle switch, a detection element, and a controller. The casing includes a support portion. The cutting unit is used for cutting a target object and moving between a first position and a second position relative to the support portion of the casing under an action of the motor. The main switch outputs a main switch state signal through a state of the main switch, controls an electric motor to perform forward rotation, and drives the cutting unit to perform a first motion: the cutting unit moves from the second position to the first position. The toggle switch outputs a toggle switch state signal through a state of the toggle switch, controls the electric motor to perform reverse rotation, and drives the cutting unit to perform a second motion: the cutting unit moves from the first position to the second position. The detection element is used for detecting a position of the cutting unit and outputting a detection signal to the controller. The controller determines or calculates an input signal to control a rotation state of the motor; where the input signal includes at least the main switch state signal, the toggle switch state signal, and the detection signal.

In some examples, different combinations of input signals correspond to different special working conditions of the electric pipe cutter.

In some examples, the special working conditions include at least a shutdown working condition, a braking working condition, or a speed regulation working condition.

In some examples, in the case where the electric pipe cutter is in the shutdown working condition, the cutting unit is driven by inertia of the electric motor to perform a deceleration motion, and in the case where the electric pipe cutter is in the braking working condition, the cutting unit stops moving; and the braking working condition is automatically performed after the shutdown working condition.

In some examples, after the electric motor stops moving forward/reversely, in the case where the main switch/toggle switch is closed again, the controller outputs no signal to another component, and only after the controller detects that the toggle switch/main switch is closed again, the controller outputs a signal to another component; or after the electric motor stops moving forward/reversely, in the case where the main switch/toggle switch is closed again, the controller controls the electric motor to stop immediately after the electric motor is started for t seconds, and only after the controller detects that the toggle switch/main switch is closed again, does the controller output a signal to the motor.

In some examples, in the case where the electric pipe cutter is in the speed regulation working condition, the main switch has a seventh position and an eighth position, where in the case where the main switch is at the eighth position, the main switch is in an open state; in the case where the main switch is at the seventh position, the main switch is in a fully closed state and the electric motor outputs a maximum rotational speed; and in the case where the main switch is between the seventh position and the eighth position, a rotational speed outputted by the electric motor changes with a position of the main switch; or the electric pipe cutter includes a speed regulation switch, where the speed regulation switch has at least a seventh position and an eighth position which correspond to different rotational speeds of the motor, respectively.

In some examples, a hardware and arithmetic unit is further included and electrically connected to the toggle switch, where in the case where the electric pipe cutter is in a non-special working condition and the toggle switch is closed, the hardware and arithmetic unit outputs a signal to control the electric motor to rotate reversely.

The present application has the following beneficial effects: the power tool in the present application controls the cutting unit to achieve quick blade retraction after cutting and has high cutting efficiency and operation convenience.

### BRIEF DESCRIPTION OF DRAWINGS

FIG. 1 is a structural view of a power tool according to an example of the present application;

FIG. 2 is a top view of the power tool in the example shown in FIG. 1;

FIG. 3 is a sectional view of an A-A plane when a brake assembly is at a fifth position in the example shown in FIG. 1;

FIG. 4 is a sectional view of an A-A plane when a brake assembly is at a sixth position in the example shown in FIG. 1;

FIG. 5 is a sectional view of a B-B plane in FIG. 2;

FIG. 6 is a sectional view of a C-C plane in FIG. 2;

FIG. 7 is an exploded view of an internal structure of the power tool in the example shown in FIG. 1 from a first perspective;

FIG. 8 is an exploded view of an internal structure of the power tool in the example shown in FIG. 1 from a second perspective;

FIG. 9 is an exploded view of a drive shaft, a transmission device, and a cutting unit of the power tool in the example shown in FIG. 1.

FIG. 10 is an exploded view of the power tool in the example shown in FIG. 1;

FIG. 11 is a structural view of a power tool according to another example of the present application;

FIG. 12 is a partial structural view of the power tool in the example shown in FIG. 11;

FIG. 13 is a schematic diagram of a control circuit of a power tool according to another example of the present application;

FIG. 14 is a schematic diagram of a principle of a controller in a power tool according to another example of the present application; and

FIG. 15 is a schematic diagram of a control circuit of a power tool according to another example of the present application.

### DETAILED DESCRIPTION

Examples of the present application are further described below in conjunction with the drawings.

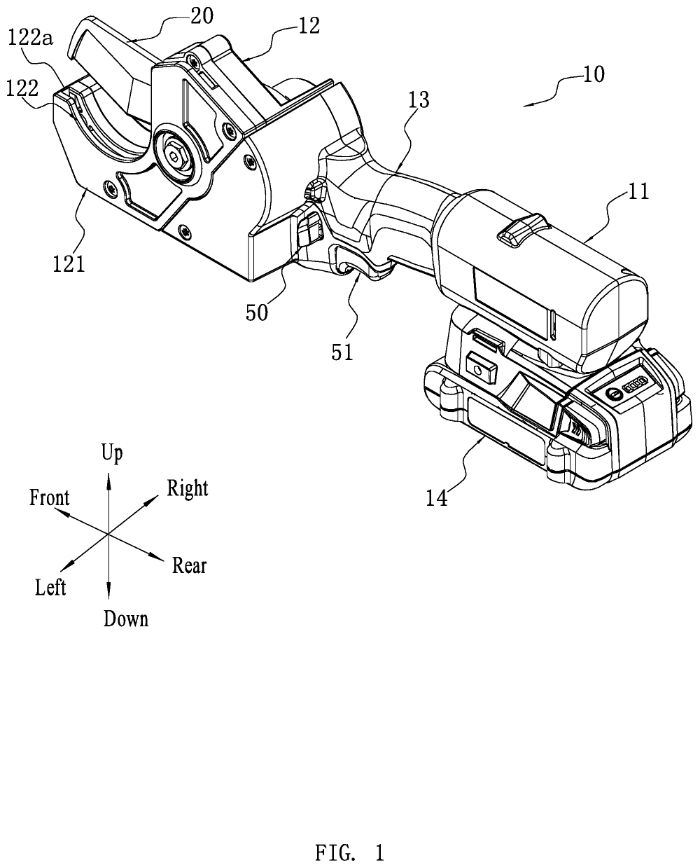

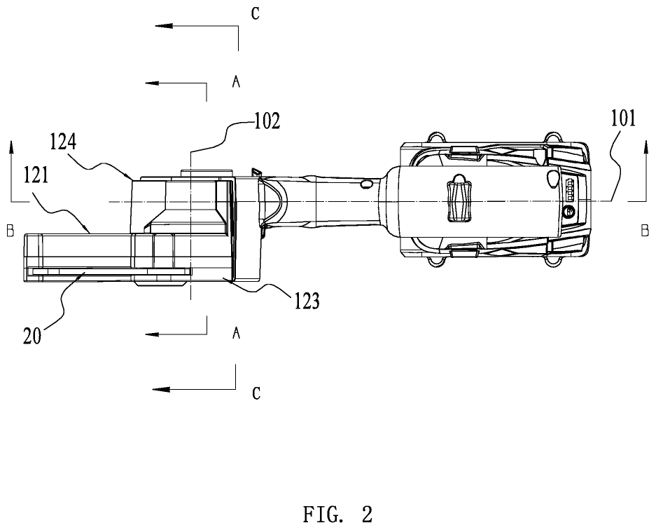

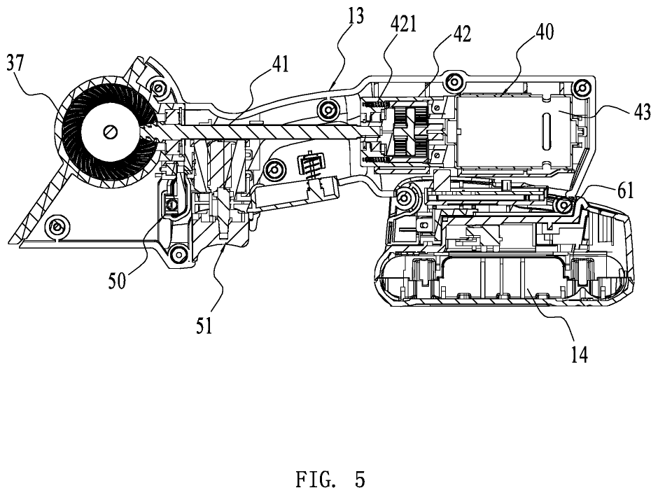

In an example, as shown in FIG. 1, a power tool 10, in particular, a pipe cutter for cutting various pipes is related. The power tool 10 includes a casing 11 and a battery pack 14. The casing 11 includes a tool portion 12 and a handle portion 13, and the battery pack 14 is connected to the handle portion 13. Specifically, the battery pack 14 is detachably connected to the handle portion 13. In other examples, the power tool may be an alternating current (AC) pipe cutter, which is not limited here. As shown in FIGS. 1 to 5, a transmission device 30 and a driving device 40 are disposed in the casing 11, and a number of switches or switch assemblies are disposed on the casing 11.

The tool portion 12 further includes a support portion 121 and is connected to a cutting unit 20, and the cutting unit 20 is used to cut a target object such as a pipe to be cut. The tool portion 12 is formed with a cavity in which part of the transmission device 30 is disposed. The cavity includes a first cavity 124 and a second cavity 123. A first end of the cutting unit 20 extends into the tool portion 12 and is disposed in the first cavity 124, and the first end of the cutting unit 20 is connected to the transmission device 30. A second end of the cutting unit 20 and most of the cutting unit 20 extend out of the tool portion 12 and are disposed opposite to the support portion 121. The support portion 121 includes a positioning portion 122, and the positioning portion 122 is at least one curved surface or groove disposed opposite to the cutting unit 20 so that the support portion 121 is disposed on one side of the pipe to be cut, the cutting unit 20 is disposed on the other side of the pipe to be cut, and the positioning portion 122 abuts against an outer wall of the pipe. The support portion 121 is further provided with a first groove 122a for accommodating the cutting unit 20 after a cutting motion. Specifically, an opening of the first groove 122a is disposed at the positioning portion 122, the opening faces the cutting unit 20, and a width of the first groove 122a is slightly greater than a width of the cutting unit 20.

The cutting unit 20 is drivingly connected to the driving device 40 through the transmission device 30 and moves between a first position and a second position relative to the support portion 121 under the action of the driving device 40 to perform a first motion and a second motion. The first motion is that the cutting unit 20 moves from the second position to the first position, and in this example, the first motion is a downward cutting action. The second motion is that the cutting unit 20 moves from the first position to the second position, and in this example, the second motion is an upward recovery action. Specifically, the second position is a position of the cutting unit 20 shown in FIG. 1. At this time, a distance between an edge of the cutting unit 20 and the positioning portion 122 should be greater than a diameter of the pipe to be cut. The first position is a position when the cutting unit 20 moves to a middle position of the first groove 122a or a bottom position of the first groove 122a. A distance between the first position and the second position should be greater than or equal to the diameter of the pipe to be cut and at least greater than or equal to two-thirds of the diameter of the pipe, so as to ensure that the pipe is completely cut or that a user can easily break off the cut pipe section after the pipe is cut.

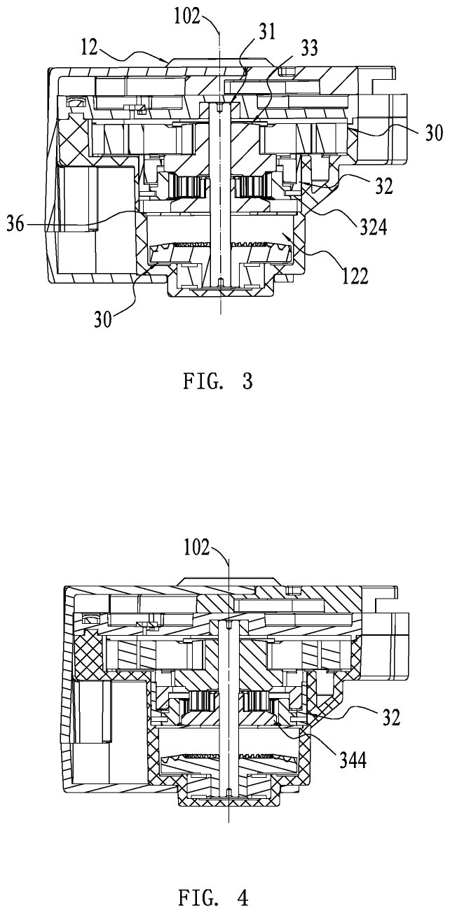

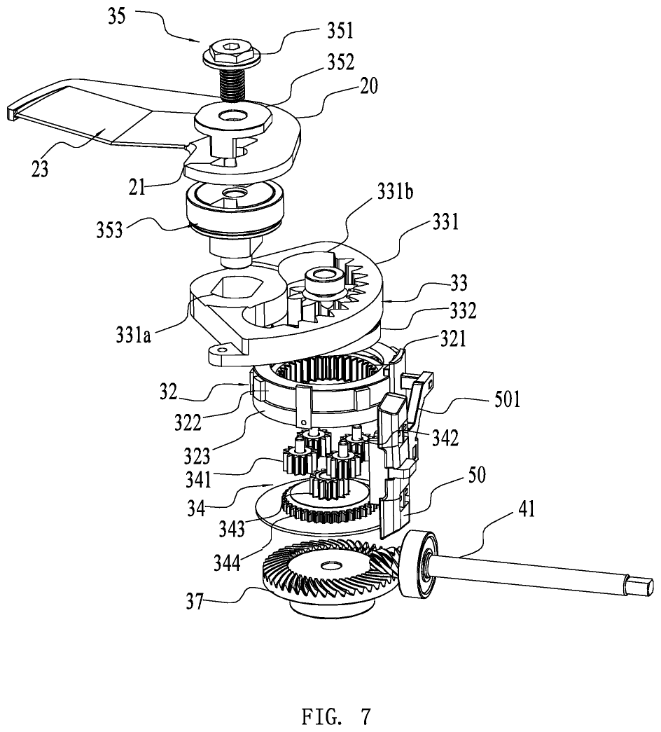

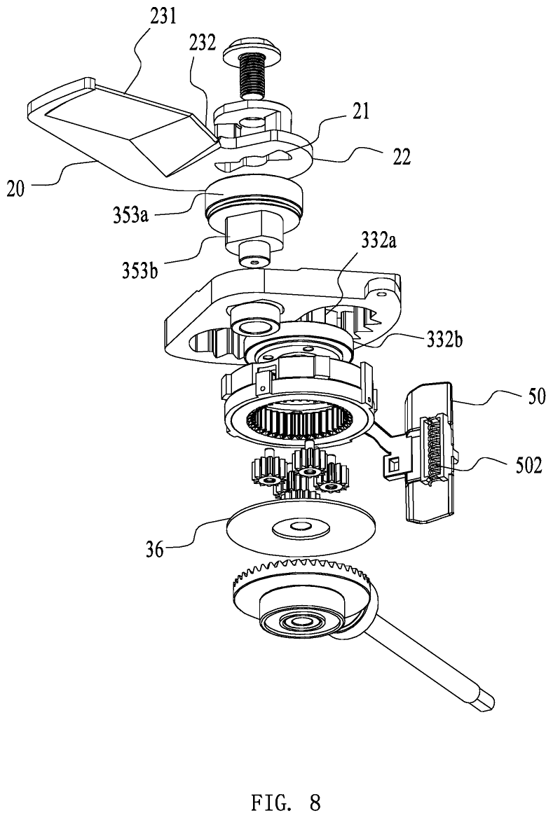

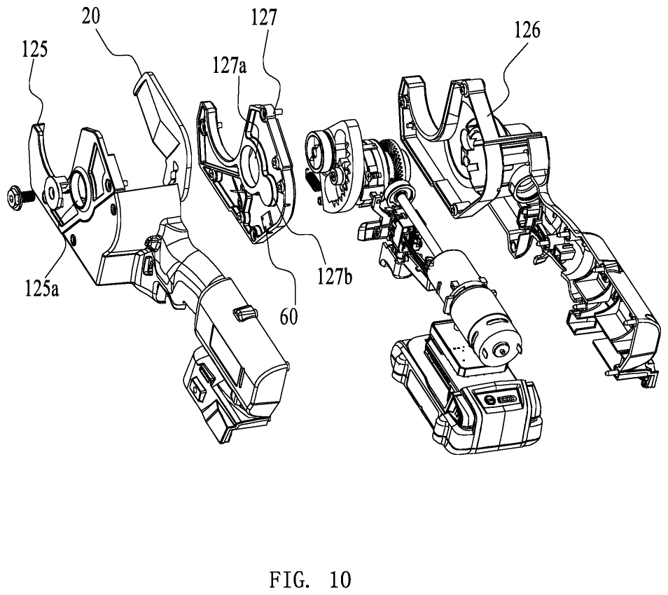

As shown in FIGS. 3 to 10, the transmission device 30 includes an output shaft 31, a drive shaft, an output gear assembly 33, a planet gear assembly 34, and a brake assembly 32. The output shaft 31 penetrates the first cavity 124 and the second cavity 123 and is disposed along a second axis 102. Both the output gear assembly 33 and the brake assembly 32 are directly or indirectly connected to the output shaft 31.

The output gear assembly 33 includes an output internal ring gear 331 and an output gear 332 disposed on the output shaft 31. An end of the output gear 332 is connected to the output internal ring gear 331, and the brake assembly 32 is provided at the other end of the output gear 332. Specifically, the output internal ring gear 331 in this example is fan-shaped and includes an output hole 331a and a ring gear portion 331b, where the ring gear portion 331b has an arc-shaped segment of teeth and meshes with the output gear 332. Further, the output gear 332 is a stepped secondary gear, that is, the output gear 332 includes a gear portion 332a and a transmission portion 332b, and the gear portion 332a meshes with the ring gear portion 331b. Further, a diameter of the gear portion 332a is less than a diameter of the transmission portion 332b so that a lower edge of the output internal ring gear 331 abuts against a surface of the transmission portion 332b.

The cutting unit 20 is connected to the output hole 331a through a connection assembly 35. The connection assembly 35 includes a first fixing pin 351, a second fixing pin 352, and a third fixing pin 353. The first fixing pin 351 and the second fixing pin 352 are connected and then inserted into a connection hole 21 at an end of the cutting unit 20, lower ends of the first fixing pin 351 and the second fixing pin 352 are connected to the third fixing pin 353 through the connection hole 21, and a lower end of the third fixing pin 353 is connected to the output hole 331a. Specifically, the center of the second fixing pin 352 is provided with a circular hole, the lower end of the first fixing pin 351 is cylindrical, and correspondingly the center of the connection hole 21 also includes a circular portion so that the cylindrical lower end of the first fixing pin 351 sequentially passes through the second fixing pin 352 and the connection hole 21. A bottom of the second fixing pin 352 includes two pins disposed relative to the lower end of the first fixing pin 351. Sections of the pins are fan-shaped, triangular or in other shapes, and correspondingly the connection hole 21 includes two hole portions with corresponding shapes. The lower end of the second fixing pin 352 is inserted into the connection hole 21. Based on the above, a sectional shape of the connection hole 21 is consistent with a combination of sectional shapes of the lower ends of the first fixing pin 351 and the second fixing pin 352. An upper end of the third fixing pin 353 has a connection groove 353a having the same shape as the connection hole 21, and the connection groove 353a is used for installing the ends of the first fixing pin 351 and the second fixing pin 352. The lower end of the third fixing pin 353 has a flat portion 353b, the flat portion 353b is connected to the output hole 331a, and correspondingly the output hole 331a is also a flat hole. The preceding special shapes of the output hole 331a and the connection hole 21 can improve connection stability and prevent the relative rotation between the cutting unit 20 and the output internal ring gear. In other examples, one fixing pin or two fixing pins may be further provided, or the connection hole 21 and the output hole 331a may be in other shapes capable of preventing rotation, which are not limited here.

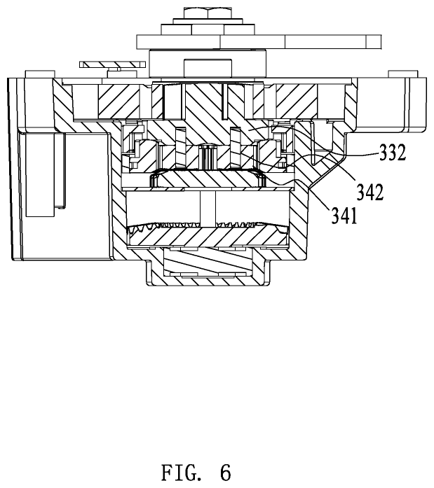

The output gear assembly 33 is drivingly connected to the planet gear assembly 34, and the planet gear assembly 34 is connected to the output shaft 31. Specifically, the planet gear assembly 34 includes several planet gears 341 and several rotating shafts 342 disposed at centers of the planet gears. The planet gears 341 mesh with a first sun gear 343 at the center of the planet gears 341. As shown in FIG. 6, a lower end of the rotating shaft 342 is connected to the planet gear 341, and an upper end of the rotating shaft 342 is fixed to the transmission portion 332b so that the output gear 332 rotates along with the planet gears 341 in a certain state. In this example, to achieve the above-mentioned transmission, four planet gears and four rotating shafts are provided. In other examples, other numbers may also be set, or other gear trains other than the planet gears may be used instead, which is not limited here.

The first sun gear 343 is disposed on the output shaft 31 and rotates when driven by the output shaft 31. A second sun gear 344 is disposed below the first sun gear 343. A diameter of the second sun gear 344 is greater than a diameter of the first sun gear 343 and greater than diameters of outer circumferences of all the planet gears 341. The first sun gear 343 and the second sun gear 344 are fixedly connected, or the first sun gear 343 and the second sun gear 344 are integrally formed.

The brake assembly 32 includes a fixed ring and the ring gear 321. The fixed ring is connected to the ring gear 321, and the partial structure of the brake assembly 32 moves between a fifth position and the sixth position. The second sun gear 344 is drivingly connected to the brake assembly 32 in a certain case. Specifically, when the brake assembly 32 is at a sixth position, the brake assembly 32 drives the ring gear 321 to move to meshes with the second sun gear 344 ring gear. And when the brake assembly 32 is at a fifth position, the ring gear 321 moves to disengage from the second sun gear 344. An upper surface of the second sun gear 344 is an arc-shaped surface, or an upper end of a gear portion of the second sun gear 344 is inclined at a certain angle, so as to ensure that teeth of the ring gear 321 more easily mesh with teeth of the second sun gear 344 when the brake assembly moves up and down. Specifically, in this example, the fixed ring includes a first fixed ring 322 and a second fixed ring 323. The second fixed ring 323 is sleeved on the first fixed ring 322 and the ring gear 321. The first fixed ring 322 and the ring gear 321 are disposed side by side, and the first fixed ring 322 is disposed above the ring gear 321. The first fixed ring 322 is fixed to another structure of the transmission device 30 or the casing 11 so as to play a limiting role. Further, the second fixed ring 323 is connected to the ring gear 321 through several fixing pieces 324, and the fixing pieces 324 penetrate and are bolted to the second fixed ring 323 and the ring gear 321 so that the movement of the second fixed ring 323 drives the movement of the ring gear 321. Further, an inner side of the ring gear 321 is covered with teeth from top to bottom, an outer side of the ring gear 321 is stepped, a lower step has a relatively large diameter and is provided with grooves for connecting the fixing pieces 324, an upper step is connected to an inner side of the first fixed ring 322, and the first fixed ring 322 is disposed between the upper step and the second fixed ring 323 so that the three form a tight connection relationship. In this example, the brake assembly 32 moves under the action of a toggle switch 50. In other examples, the movement of the brake assembly 32 may be directly controlled by a controller 70 instead of being controlled by the toggle switch 50.

The fixed ring is connected to the toggle switch 50 through a connection rod 501, and the toggle switch 50 is disposed on the handle portion 13. In this example, the toggle switch 50 has a first end and a second end and passes through the handle portion 13 along a left and right direction so that the first end and the second end protrude from left and right sides of the handle portion 13, respectively. The toggle switch 50 is movable in the left and right direction, has a third position and a fourth position, and moves between the third position and the fourth position. Specifically, an end of the connection rod 501 is fixedly connected to the second fixed ring 323, and the other end of the connection rod 501 is connected to the toggle switch 50 and may also be integrally formed with the toggle switch 50.

The transmission device 30 further includes a support pad 36 for supporting and defining a position of part of the transmission device. Specifically, the support pad 36 is configured to support the brake assembly 32. As shown in FIGS. 3 and 4, specifically, in this example, an outer edge of the support pad 36 is clamped in a corresponding groove on an inner wall of the tool portion 12 so that the support pad 36 supports upper mechanisms that include the brake assembly and the output gear assembly. Further, the support pad 36 is disposed in the middle of the first cavity 124.

The transmission device 30 further includes a transmission gear 37 that is disposed in a lower part of the first cavity 124 and drivingly connected to the driving device 40 through a drive shaft 41. An end of the drive shaft 41 is disposed in the tool portion 12 and connected to the transmission gear 37, and the other end of the drive shaft 41 and most of the drive shaft 41 are disposed in the handle portion 13. The drive shaft 41 is disposed substantially along a first axis 101. The transmission gear 37 is disposed on and fixedly connected to the output shaft 31. A tooth surface of the transmission gear 37 is tapered, and the tapered tooth surface meshes with a tapered portion at an end of the drive shaft 41.

The driving device 40 further includes a gear box 42 and an electric motor 43, where the electric motor is configured to output rotation, and the gear box 42 is configured to decelerate the motion. The electric motor 43 is disposed at a rear end of the handle portion 13, and the gear box 42 is connected to the electric motor 43 and disposed in front of the electric motor 43. The gear box 42 is connected to an end of the drive shaft 41 farther from the transmission gear 37 and configured to provide a certain deceleration effect. Due to inconsistent transmission directions, a bevel gear is disposed at an end of the drive shaft 41, and correspondingly, an upper portion of the transmission gear 37 is the tapered tooth surface.

A main switch 51 and the toggle switch 50 are provided on the handle portion 13, where the main switch 51 is configured to control the electric motor 43 to be started and stopped, and the toggle switch 50 controls the movement of the brake assembly 32 through the connection rod 501. The toggle switch 50 is provided with a biasing element 502, where a peripheral side of the biasing element 502 abuts against an inner wall of the toggle switch 50, two ends of the biasing element 502 abut against an inner wall of the casing separately, and the biasing element 502 provides a restoring force for making the toggle switch 50 to move between the third position and the fourth position so that the toggle switch 50 is automatically reset from the fourth position to the third position, thereby ensuring the feeling of use and operation convenience.

The tool portion 12 includes a first tool casing 125 and a second tool casing 126, and an intermediate tool casing 127 is further provided between the first tool casing 125 and the second tool casing 126. In this example, the first tool casing 125 and the second tool casing 126 are two half casings disposed on the left and right of the internal structure, respectively. Specifically, the second tool casing 126 forms part of the first cavity and the second cavity, and the first tool casing 125 forms a “cover” of the above-mentioned cavities. The intermediate tool casing 127 is configured to divide the internal structure and disposed between most of the transmission device 30 and the cutting unit 20. The first tool casing 125 is provided with a first through hole 125a, the intermediate tool casing 127 is provided with an intermediate through hole 127a, and the first through hole 125a and the intermediate through hole 127a are used for the connection assembly 35 to pass through. The cutting unit 20 is disposed between the first tool casing 125 and the intermediate tool casing 127. The first groove 122a is formed between the first tool casing 125 and the intermediate tool casing 127.

The cutting unit 20 includes a connection portion 22 and a blade portion 23, where the blade portion 23 includes a first blade portion 231 and a second blade portion 232. In this example, the first blade portion 231 and the connection portion 22 are located at different heights in the left and right direction mainly due to the connection relationship between the cutting unit 20 and the transmission device 30 or the layout of the tool portion 12. Specifically, the first blade portion 231 is disposed on a plane perpendicular to the left and right direction, so as to ensure the parallelism of a cutting surface of the pipe to be cut. The second blade portion 232 is inclined relative to the first blade portion 231 and disposed between the first blade portion 231 and the connection portion 22. Protective casings are provided at outer edges of the first blade portion 231 and the second blade portion 232 to cover sides of the first blade portion 231 and the second blade portion 232 facing away from the pipe to be cut, thereby ensuring the safety of the user.

The handle portion 13 and the battery pack 14 are each disposed symmetrically with respect to the first axis 101. The battery pack 14 is disposed below the handle portion 13, and a lower end surface of the battery pack 14 and a lower end surface of the tool portion 12 are located on the same plane in an up and down direction. Alternatively, the lower end surface of the tool portion 12 is higher than the lower end surface of the battery pack 14 in the up and down direction, and in this case, the handle portion 13 includes at least a part inclined with respect to a front and rear direction. That is, an orthographic projection of the battery pack 14 on a plane perpendicular to the front and rear direction is a first projection, an orthographic projection of the casing on the plane perpendicular to the front and rear direction is a second projection, and the first projection is at least partially below the second projection. The preceding structure and layout ensure that the center of gravity of the power tool 10 is located in the handle so that the power tool 10 is easy for the user to use and convenient to place.

The power tool 10 further includes a steering controller 60 configured to switch the electric motor 43 between forward rotation and reverse rotation according to a state of the power tool 10 or an operation of the user so that the cutting unit 20 performs the first motion or the second motion. In this example, the steering controller 60 is a sensor element and senses and feeds back a position of the toggle switch 50 to a circuit board 61 to control the electric motor 43 to switch between the forward rotation and the reverse rotation. So, in this example, when the main switch 51 is operated, the electric motor 43 rotates forward to drive the cutting unit 20 to move from the second position to the first position. When the main switch 51 is not operated and the toggle switch 50 is operated, the toggle switch 50 controls the electric motor 43 rotates reversely and drives the brake assembly 32 to move to the sixth position, so that the cutting unit 20 moves from the first position to the second position at a faster speed.

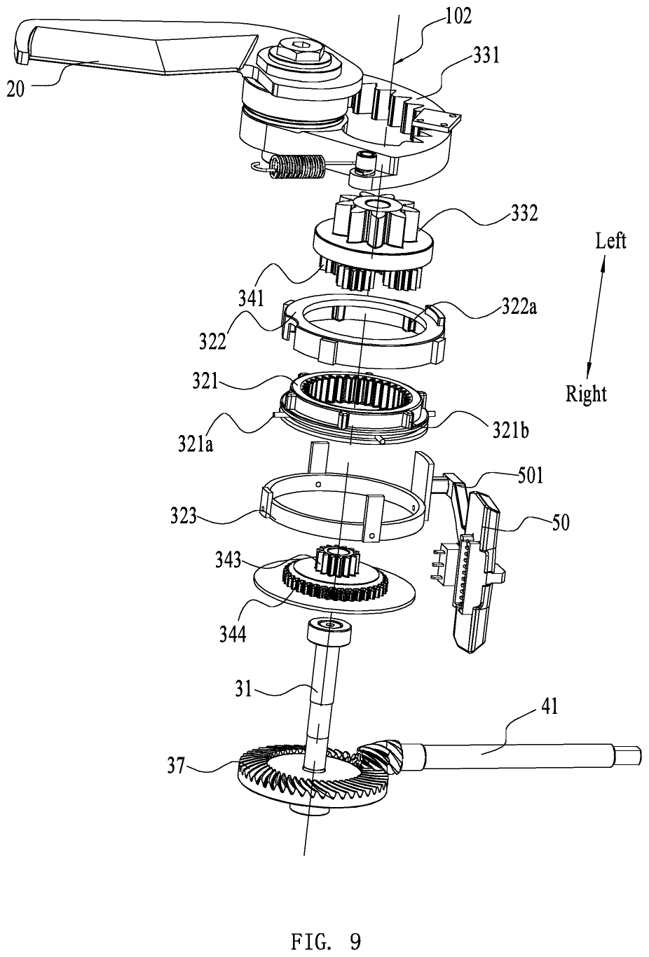

As shown in FIG. 9, the drive shaft 41 is fixedly connected to the tapered portion, the output shaft 31 is fixedly connected to the transmission gear 37, and the transmission gear 37 cooperates with the tapered portion, so that the drive shaft 41 can drive the output shaft 31 to move at a first rotational speed. The first sun gear 343 and the second sun gear 344 are fixedly connected to the output shaft 31, the planet gears 341 is meshed with the first sun gear 343, and the planet gears 341 is also meshed with the ring gear 321. The planet gears 341 is also rotatably disposed on the output gear 332 through the rotating shaft 342, the output gear 332 is rotatably mounted to the output shaft 31, and the output gear 332 outputs power to drive the cutting unit 20 to move. The first fixed ring 322 is fixed relative to the casing 11. The ring gear 321 is connected to the second fixed ring 323 through a connecting piece 321a, and the second fixed ring 323 drives the ring gear 321 to move left and right along the second axis 102 through the connecting piece 321a, and the connecting piece 321a also allows the ring gear 321 to rotate relative to the second fixed ring 323. The toggle switch 50 is connected to the second fixed ring 323 through the connecting rod 501. When the toggle switch 50 is moved to the fourth position, the toggle switch 50 drives the second fixed ring 323 and the ring gear 321 to move to the sixth position to the right. At this time, the inner teeth of the ring gear 321 mesh with the second sun gear 344. When the toggle switch 50 is moved to the third position, the toggle switch 50 drives the second fixed ring 323 and the ring gear 321 to move to the fifth position to the left. At this time, the ring gear 321 is disengaged from the second sun gear 344 and a locking portion 321b outside the ring gear 321 is matched with a matching portion 322a formed on the first fixed ring 322, and the ring gear 321 is fixed relative to the first fixed ring 322. So, the first sun gear 343, the planet gears 341, the ring gear 321 and the output gear 332 constitute a deceleration assembly, the deceleration assembly is a planetary gear train 34a, and the planetary gear train 34a has a first reduction ratio that is not zero. The planetary gear train 34a connects the output shaft 31 and the output gear 332

In this way, when the main switch 51 is operated by the user, the electric motor 43 is rotated forward. At the same time, the toggle switch 50 is not operated, the toggle switch 50 is at the third position, the ring gear 321 is at the fifth position, the ring gear 321 is separated from the second sun gear 344 and fixed relative to the first fixed ring 322, and the planetary gear train 34a composed of the first sun gear 343, the planet gears 341, the ring gear 321, and the output gear 332 has a deceleration effect. At this time, the electric motor 43 drives the output shaft 31 to rotate at the first rotational speed, and at the same time, the output gear 332 rotates at a second rotational speed lower than the first rotational speed through the deceleration action of the planetary gear train 34a, so that the cutting unit 20 moves from the second position to the first position at a lower first moving speed.

When the main switch 51 is not operated and the toggle switch 50 is operated, the toggle switch 50 moves to the fourth position, the ring gear 321 is at the sixth position, the ring gear 321 meshes with the second sun gear 344 and rotates synchronously. A whole composed of the first sun gear 343, the planet gears 341, the ring gear 321 and the output gear 332 has no reduction ratio, or a second reduction ratio of the whole is 0 at this time. In this way, at this time, the electric motor 43 reverses and drives the output shaft 31 to rotate at the first rotation speed, and at the same time, the output gear 332 also rotates at the first rotation speed, so that the cutting unit 20 moves from the first position to the second position at a higher second moving speed. The higher second moving speed is greater than the lower first moving speed.

In another example, the second reduction ratio of the deceleration assembly when the toggle switch is at the fourth position is smaller than first reduction ratio of the deceleration assembly when the toggle switch is at the third position.

The power tool 10 further includes a gear skip mechanism 421. After the cutting unit 20 moves to the first position or the second position, the gear skip mechanism 421 causes the driving device 40 or the transmission device 30 to be in a clutch state. Alternatively, when the cutting unit 20 moves between the first position and the second position, in the case where the electric motor 43 is locked or a force applied to the cutting unit 20 exceeds a maximum load of the electric motor 43 due to problems such as a target object, the gear skip mechanism 421 causes the driving device 40 or the transmission device 30 to be in the clutch state, thereby protecting the internal structure of the power tool 10. In this example, the gear skip mechanism 421 includes several elastic members and an internal ring gear with an inclined surface. The elastic members abut against the inclined surface. The gear skip mechanism 421 is preferably disposed in the gear box 42 at a front end of the electric motor 43. In this case, the torque is relatively small, which is convenient to achieve the structure setting. In other examples, the gear skip mechanism 421 may also be other structures capable of achieving a clutch function, which is not limited here.

This example is further described in conjunction with a working process.

After aligning the power tool 10 to a standby position, the user presses the main switch 51 and the electric motor 43 starts. Driven by the electric motor 43, the drive shaft 41 rotates to drive the transmission gear 37 of the transmission device 30 to rotate, thereby driving the output shaft 31 to rotate. In this case, the electric motor rotates forward, and the output shaft 31 also rotates forward. The toggle switch 50 is at the third position, and the brake assembly 32 is at the fifth position. As shown in FIG. 3, the ring gear 321 is separated from the second sun gear 344. Driven by the output shaft 31, the first sun gear 343 transmits rotation to the planet gears 341, the output gear 332 rotates under the action of the rotating shafts 342 at the centers of the planet gears 341 and rotates relative to the output shaft 31, and the output gear 332 drives the output internal ring gear 331 to rotate, thereby driving the cutting unit 20 to move from the second position to the first position to perform the first motion and cut the pipe to be cut. The user toggles the toggle switch 50 to the fourth position and the steering controller 60 outputs a signal to the circuit board 61, so as to control the electric motor 43 to rotate reversely, and the output shaft 31 rotates reversely. At the same time, the brake assembly 32 is at the sixth position. As shown in FIG. 4, the ring gear 321 meshes with the second sun gear 344 so as to fix the second sun gear 344 and the first sun gear 343, and the output gear 332 rotates under the action of the output shaft 31 to drive the output internal ring gear 331 to rotate so that the cutting unit 20 moves from the first position to the second position, thereby achieving the second motion and the retraction of the cutting unit 20. Since the driving of the second motion is not decelerated by the planet gear assembly 34 and the second motion is performed directly based on the output shaft 31, a speed of the second motion is greater than a speed of the first motion so that quick blade retraction is achieved. In this example, through experiments, the speed of the second motion is at least 3 times the speed of the first motion. The blade can be retracted through one switch, thereby improving the working efficiency of the tool.

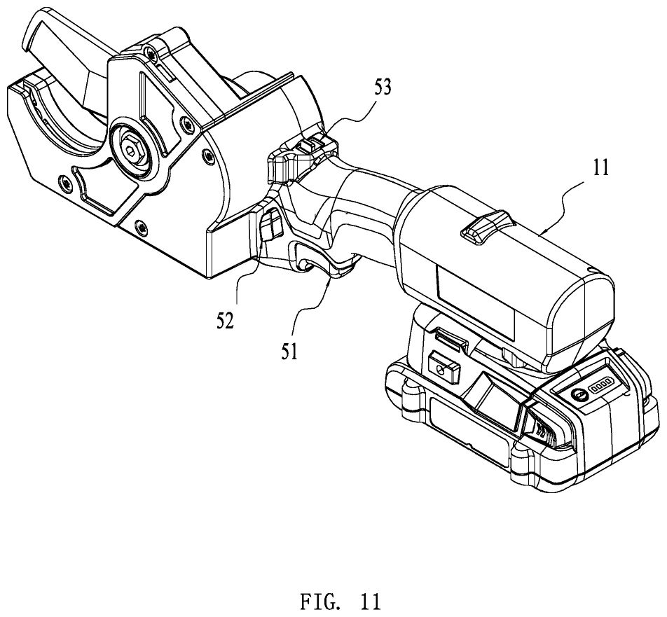

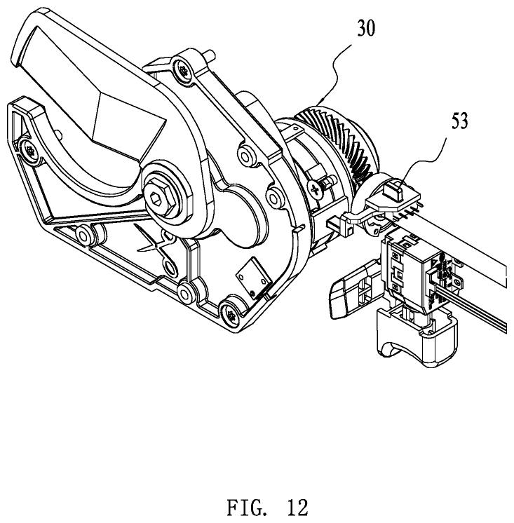

In an example, as shown in FIGS. 11 and 12, a steering switch 52 and a brake switch 53 are provided on the casing 11, where the steering switch 52 moves between a left position and a right position and controls the electric motor 43 to perform the forward rotation and the reverse rotation respectively, and the brake switch 53 controls the brake assembly to move between the fifth position and the sixth position so that the brake assembly is separated from or engaged with the sun gear. In this example, after completing a first action of cutting, the user needs to actively adjust the steering switch 52 to make the electric motor rotate reversely and then adjust the brake switch 53. The advantage of this structure is high stability. In other examples, the brake switch 53 and the steering switch 52 are electrically connected so that after the brake switch 53 moves to the fourth position, the steering switch 52 is automatically toggled to the right position, or the circuit board 61 controls the steering switch 52 to perform the preceding action, finally achieving the reverse rotation of the electric motor 43.

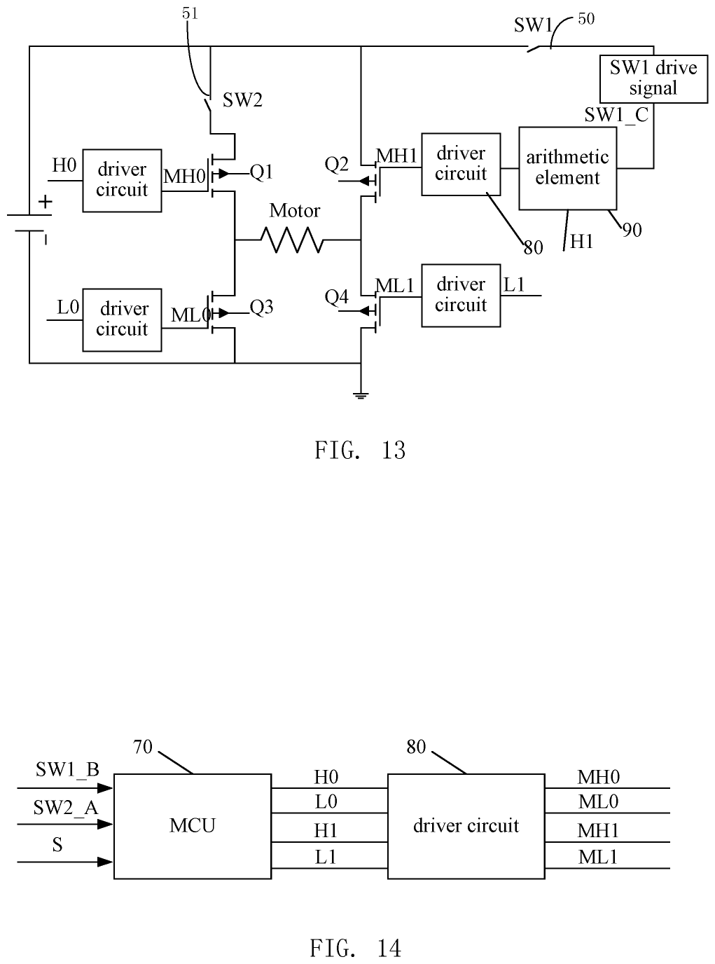

In an example, as shown in FIGS. 13 and 14, the power tool in this example, especially an electric pipe cutter, further includes the controller 70 that includes any one or a combination of a single-chip microcomputer or a microcontroller unit (MCU), an advanced reduced instruction set computing (RISC) machine (ARM) chip, and a general-purpose digital signal processor (DSP) chip. The controller 70 is disposed in the circuit board 61 and performs a logical operation according to an inputted signal to control a rotation state of the electric motor 43.

The circuit board 61 is disposed between the battery pack 14 and the handle portion 13. Specifically, the circuit board 61 may be disposed between the electric motor 43 in the handle portion 13 and the battery pack 14, where a connection base of the battery pack 14 is disposed, and the circuit board 61 may be disposed in the connection base. A power supply circuit is electrically connected to the controller 70 and configured to convert the electrical energy from a power supply into the electrical energy for the operation of the controller 70 and other circuit components. In this example, the power supply is the battery pack 14. Therefore, the power supply circuit may include a direct current-direct current (DC-DC) conversion chip. It is to be understood by those skilled in the art that the power supply is not limited to the battery pack 14, and circuit elements may also be powered by using mains power or an AC power supply in conjunction with corresponding rectifying, filtering and voltage regulating circuits. In this case, the power supply circuit includes the rectifying, filtering and voltage regulating circuits, and the circuit board 61 may be disposed at other spare positions of the handle portion 13.

The main switch 51 on the handle portion 13 is electrically connected to the controller 70, and the main switch 51 is open or closed for controlling the electric motor 43 to be started or stopped. When the main switch 51 is closed, the electric motor 43 may perform the forward rotation, thereby driving the cutting unit 20 to perform the first motion. In this example, the main switch 51 is a mechanical switch, preferably a high-current mechanical switch. The controller 70 may detect an off signal of the main switch 51, perform the corresponding logical operation and determination, and output a signal to other assemblies.

The toggle switch 50 is electrically connected to the controller 70 and outputs a switch state signal SW1_C according to a state change of the toggle switch 50. The electric pipe cutter further includes an arithmetic unit 90 disposed on the circuit board 61. The arithmetic unit 90 performs an AND operation according to the switch state signal SW1_C and other input signals to control the electric motor 43 to perform the reverse rotation, thereby driving the cutting unit 20 to perform the second motion. At the same time, the switch state signal SW1_C is transmitted to the controller 70, and the controller 70 performs the logical determination and operation according to the off signal of the main switch 51 and the switch state signal SW1_C and finally outputs a signal to the other assemblies.

As shown in FIG. 13, the electric pipe cutter in this example further includes a metal-oxide-semiconductor (MOS) transistor assembly (Q1, Q2, Q3, and Q4). The electric motor 43 is controlled to rotate forward or reversely by a driving control signal outputted by the MOS transistor assembly. In other examples, optionally, the MOS transistor assembly may also adopt field-effect transistors, insulated-gate bipolar transistors (IGBT) and the like, which is not limited here. The controller 70 may be connected to a driver circuit 80 through several drive ports, and the driver circuit 80 is electrically connected to windings of the electric motor 43 so that a signal voltage conforms to an applicable voltage of the MOS transistor assembly, and then a rotor of a brushed electric motor in this example is driven to rotate. In other examples, the electric motor may also be a brushless motor, and the circuit should be adjusted adaptively. An end of the MOS transistor assembly is electrically connected to a drive signal output terminal of the driver circuit 80, and the other end of the MOS transistor assembly is electrically connected to the windings of the electric motor 43. On states of Q1, Q2, Q3, and Q4 change according to signals outputted by the controller 70. Specifically, when the main switch 51 is closed, the circuit is on and a certain signal is outputted to the controller 70 at the same time so that Q1 and Q4 are turned on, and the electric motor 43 is driven to rotate forward. On the contrary, when the main switch 51 is open, the circuit is disconnected and a certain signal is outputted to the controller 70 at the same time so that Q1 and Q4 are not turned on, and the electric motor 43 stops operating. In other examples, the drive signal applied by the controller 70 to the driver circuit may be a pulse-width modulation (PWM) control signal and may control the electric motor to accelerate, decelerate, rotate counterclockwise or rotate clockwise.

The toggle switch 50 has two states: a closed state and an open state, and the toggle switch 50 outputs the switch state signal SW1_C to the arithmetic unit 90. When the toggle switch 50 is closed, a high level is outputted to the arithmetic unit 90; and when the toggle switch 50 is open, a low level is outputted to the arithmetic unit 90. The arithmetic unit 90 performs an AND operation on the switch state signal SW1_C and the input signal. Only when the switch state signal SW1_C and an output signal of the controller 70 are both at the high level, is a high level drive signal outputted to the subsequent elements. Specifically, when the toggle switch 50 is closed, the arithmetic unit 90 detects that the switch state signal SW1_C is at the high level, and the arithmetic unit 90 detects the output signal of the controller 70 and performs a logical operation. When the input signal and the switch state signal SW1_C are both at the high level, the arithmetic unit 90 outputs the high level to the driver circuit 80, the driver circuit 80 outputs a high level drive signal to Q2 and Q3, Q2 and Q3 are turned on, and the electric motor 43 is driven to rotate reversely. On the contrary, when the toggle switch 50 is open, the arithmetic unit 90 detects that the switch state signal SW1_C is at a low level, the arithmetic unit 90 outputs the low level to the driver circuit 80, the driver circuit 80 outputs a low level drive signal to Q2 and Q3, Q2 and Q3 are not turned on, and the electric motor 43 stops operating. In this example, the toggle switch 50 is an electronic switch, and an input voltage value does not match the MOS transistor assembly. The driver circuit 80 is used for improving a driving capability of the switch state signal SW1_C so that the output signal matches the MOS transistor assembly. In this example, the arithmetic unit 90 performs determination through the AND operation and the controller 70 does not directly perform the logical operation, thereby ensuring the corresponding speed of the circuit and the operation stability of the circuit.

As shown in FIG. 14, when the toggle switch 50 is closed or open, the controller 70 also receives a switch state signal SW1_B. When the main switch 51 is closed or open, the controller 70 receives a main switch signal SW2_A. The controller 70 performs determination according to the switch state signal SW1_B, the main switch signal SW2_A and an input signal S. When the electric pipe cutter is in a non-special working condition, a high-level signal H1 is outputted to the arithmetic unit 90, and after a result of the AND operation is high, the high level signal H1 is outputted to the driver circuit 80, converted into a high level drive signal MH1, and outputted to the MOS transistor assembly, and the electric motor 43 is driven to rotate reversely.

The input signal S is a signal obtained by the controller 70 according to a state of the cutting unit 20 and includes two types of signals: a high level signal and a low level signal. Specifically, the preceding special working conditions include at least a shutdown working condition, a braking working condition, or a speed regulation working condition. In at least one of the shutdown working condition, the braking working condition, or the speed regulation working condition, the controller 70 outputs a low level signal to the arithmetic unit 90, and after the result of the AND operation is low, the low level signal is outputted to the driver circuit 80, converted into a low level drive signal, and outputted to the MOS transistor assembly, and the electric motor 43 is not driven to move.

The shutdown working condition refers to that the electric motor 43 still has a certain output rotational speed under the action of inertia in cases such as the power outage of the electric motor 43. The shutdown working condition is generally applicable to a case after the electric pipe cutter completes forward cutting, that is, the cutting unit 20 completes or is about to complete the first motion and also applicable to another case where the user needs to stop the tool. The shutdown working condition of the electric motor 43 is implemented by at least one of the following actions to which the present application is not limited: a. the main switch 51 is open and the toggle switch 50 is open; b. the main switch 51 is closed and the toggle switch 50 is closed; or c. a detection element detects that a blade moves to a stop position. Action a corresponds to the following usage situation: after the main switch 51 of the electric pipe cutter is pressed, the cutting unit 20 completes the forward cutting, the user releases the main switch 51 but does not press the toggle switch 50, and the controller 70 outputs a low level signal at this time. Action b corresponds to the following usage situation: when the main switch 51 is in the closed state, the toggle switch 50 is closed again, the controller 70 outputs the low level signal, and after the AND operation, the low level drive signal is outputted, and the electric motor 43 does not rotate reversely; or when the toggle switch 50 is in the closed state, the main switch 51 is closed again, the controller 70 outputs the low level signal, and after the AND operation, the low level drive signal is outputted, and the electric motor 43 does not rotate reversely. Action c corresponds to the following usage situation: the electric pipe cutter further includes the detection element, and when the electric pipe cutter almost completes the forward cutting of a target object, the cutting unit 20 moves from the second position to the stop position close to the first position, and the detection element detects that the cutting unit 20 reaches the stop position, generates a corresponding input signal S and transmits the input signal S to the controller 70, thereby outputting the low level signal. Specifically, the detection element may be a sensor, especially a Hall element sensor, and a magnetic body is disposed in the cutting unit 20. When the cutting unit 20 moves to the stop position, the Hall sensor senses the magnetic body and outputs a corresponding signal. In other examples, other types of sensors or detection elements may also be used, which is not limited here.

When the electric pipe cutter is in the braking working condition, the cutting unit 20 stops moving. Specifically, the cutting unit 20 is in a clutch state from the transmission device 30, the transmission device 30 is in the clutch state inside, the transmission device is in the clutch state from the driving device 40, or the driving device 40 is in the clutch state inside so that the cutting unit 20 can stop moving immediately. The gear skip mechanism disposed in the electric pipe cutter can implement the clutch state. Alternatively, the controller 70 outputs signals to Q3 and Q4 according to received signals to directly make the MOS transistor assembly short-circuited and further cause the electric motor 43 to stop moving quickly so that the cutting unit 20 can stop moving immediately. The braking working condition is implemented by at least the following action to which the present application is not limited: the detection element detects that the blade moves to a braking position. For the braking working condition, when the electric pipe cutter completes the forward cutting of the target object, the cutting unit 20 moves from the second position to the first position which is the braking position, and the detection element detects that the cutting unit 20 reaches the braking position, generates the corresponding input signal S and transmits the input signal S to the controller 70, thereby outputting the low level signal. When the electric pipe cutter retracts the blade in a reverse direction, the cutting unit 20 moves from the first position to the second position which is the braking position.

In other examples, when the shutdown working condition does not include the preceding condition b, the braking working condition is further implemented by the following condition: the main switch is always in the closed state, and after the toggle switch 50 is closed, the controller 70 outputs a signal to the arithmetic unit 90 to control the electric motor 43 to rotate reversely; and after the main switch 51 is open, the cutting unit 20 brakes. At this time, the cutting unit 20 is kept at an angle desired by the user, which is conducive to controlling an angle at which the cutting unit is opened in the reverse direction according to a thickness of the pipe, thereby saving the cutting time.

In another example, the braking working condition is performed automatically after the shutdown working condition. Specifically, only one position is set in the electric pipe cutter, which may be the stop position close to the first position or the braking position similar to or the same as the first position, preferably the stop position so that a space can be reversed for a sliding motion of the cutting unit 20 driven by inertial deceleration of the motor. According to the time and distance of the sliding motion, the braking working condition may be configured to be automatically performed T seconds after the shutdown working condition.

The electric pipe cutter further has a speed regulation switch or the main switch is an electronic switch with a speed regulation function. When the electric pipe cutter is in the speed regulation working condition, the main switch 51 has a seventh position and an eighth position. In the case where the main switch 51 is at the eighth position, the main switch 51 is in the open state. In the case where the main switch 51 is at the seventh position, the main switch 51 is in a fully closed state and the electric motor outputs a maximum rotational speed. In the case where the main switch 51 is between the seventh position and the eighth position, a rotational speed outputted by the electric motor changes with a position of the main switch. Specifically, the position of the main switch 51 is changed so as to change the resistance value of an element, thereby achieving the speed regulation of the motor. A switch based on other principles may also be used, which is not limited here. When the main switch 51 is between the seventh position and the eighth position, the input signal S of the controller 70 is at the low level, and the controller 70 outputs the low level signal. In other examples, the electric pipe cutter includes a speed regulation switch SW3, the speed regulation switch SW3 has at least a seventh position and an eighth position which correspond to different rotational speeds of the motor, respectively. The speed regulation switch SW3 also has a ninth position. When the speed regulation switch is at the ninth position, the speed regulation switch is in the open state. When the speed regulation switch SW3 is at the seventh position or the eighth position, the input signal S of the controller 70 is at the low level, and the controller 70 outputs the low level signal.

In this example, a speed at which the cutting unit 20 performs the second motion is greater than a speed at which the cutting unit performs the first motion, which is mainly implemented in accordance with the principle in example one. In this example, when the cutting unit 20 completes the second motion, the cutting unit 20 moves to the second position, the stop position is set close to the second position, the braking position is also set at the second position, and the control method is the same as the above.

The special working conditions further include a self-stop working condition, which is a working condition similar to the shutdown working condition. In this example, after the electric motor 43 stops moving forward, that is, after the shutdown working condition or the braking working condition in a forward direction is performed, if the main switch 51 is closed again, the controller 70 outputs no signal or outputs the low level signal to the motor; only after the controller detects that the toggle switch 50 is closed again, the controller 70 outputs the high level signal to the electric motor 43. After the electric motor 43 stops moving reversely, that is, after the shutdown working condition or the braking working condition in the reverse direction is performed, if the toggle switch 50 is closed again, the controller 70 outputs no signal or outputs the low level signal to the motor; only after the controller detects that the main switch 51 is closed again, the controller 70 outputs the high level signal to the electric motor 43. The self-stop working condition may prevent the cutting unit 20 that has reached a bottom position (the first position or the second position) from moving and causing damages to the mechanical structure, especially the inside of the transmission device.

In other examples, in the self-stop working condition, the following solution is adopted: after the electric motor 43 stops moving, if the main switch or the toggle switch is closed again, the controller 70 outputs a signal to control the electric motor to stop immediately after the electric motor is started for t seconds, and only after the controller 70 detects that the toggle switch or the main switch is closed again, the controller 70 outputs the high level signal to the electric motor 43. Specifically, t≤2s. In this example, the mechanical structure of the electric pipe cutter, especially the transmission device, is allowed to withstand the phenomenon of sliding teeth caused by the movement beyond the bottom position for the time t so that the user hears a “click” sound from the electric pipe cutter and is aware that the cutting unit has reached a position where the cutting unit needs to stop, and then the cutting unit stops immediately so as to protect the mechanical structure. The detection element also works normally in the self-stop working condition, thereby preventing the following case: the cutting unit has not moved to the second position, the first position or the stop position after the electric motor stops moving.

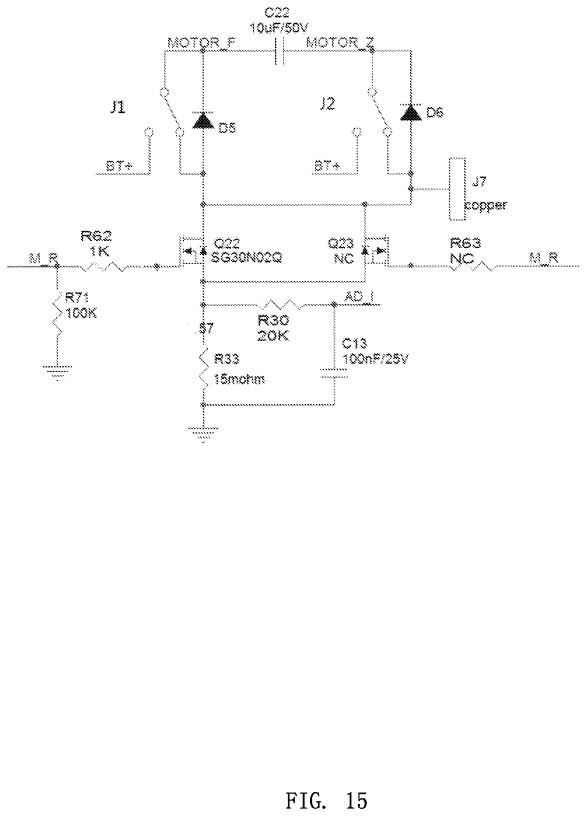

In an example, as shown in FIG. 15, a main switch J1 and a toggle switch J2 are both mechanical switches, the controller 70 may detect signals of the two switches, an AND operation is performed inside the controller 70, and the control method is the same as the control method in example three.

In different examples of the present application, the same or similar components use the same reference numerals, and the descriptions for the same or similar components are not repeated in different examples.

The above illustrates and describes basic principles, main features and advantages of the present application. It is to be understood by those skilled in the art that the preceding examples do not limit the present application in any form, and technical solutions obtained through equivalent substitutions or equivalent transformations fall within the scope of the present application.

What is claimed is:

1. A power tool, comprising:
a casing comprising a support portion;
a cutting unit for cutting a target object;
a driving device for driving the cutting unit to move between a first position and a second position relative to the support portion;
a transmission device for connecting the driving device to the cutting unit; and
a toggle switch comprising at least a third position and a fourth position;
wherein, when the toggle switch is placed into the third position, the cutting unit performs a first motion under the action of the driving device and the cutting unit moves from the second position to the first position, when the toggle switch is placed into the fourth position, the cutting unit performs a second motion under the action of the driving device and the cutting unit moves from the first position to the second position, and a speed at which the cutting unit performs the second motion is greater than a speed at which the cutting unit performs the first motion.

2. The power tool of claim 1, wherein the transmission device comprises an output shaft connected to the driving device, an output gear connected to the cutting unit, and a deceleration assembly connecting the output gear to the output shaft.

3. The power tool of claim 2, wherein a reduction ratio of the deceleration assembly when the toggle switch is at the fourth position is smaller than a reduction ratio of the deceleration assembly when the toggle switch is at the third position.

4. The power tool of claim 2, wherein the deceleration assembly has a reduction ratio that is non-zero when the toggle switch is at the third position and the deceleration assembly has no reduction ratio when the toggle switch is at the fourth position.

5. The power tool of claim 1, wherein the driving device comprises an electric motor, the cutting unit is driven to move from the second position to the first position when the electric motor rotates forward, and the cutting unit is driven to move from the first position to the second position when the electric motor reverses.

6. The power tool of claim 5, wherein the power tool further comprises a main switch for controlling the electric motor and the electric motor rotates forward when the main switch is operated.

7. The power tool of claim 6, wherein the electric motor reverses when the main switch is not operated and the toggle switch is operated.

8. The power tool of claim 1, further comprising a steering controller configured to switch the driving device between forward rotation and reverse rotation according to a state of the power tool or an operation of a user so that the cutting unit performs the first motion or the second motion.

9. The power tool of claim 1, wherein the driving device comprises an electric motor configured to drive the cutting unit perform the second motion.

10. The power tool of claim 1, wherein the driving device comprises an electric motor, the power tool further comprises a battery pack for powering the electric motor, the electric motor is disposed in the casing, and the battery pack is disposed at a rear end of the casing and disposed at a lower side of the electric motor.

11. The power tool of claim 10, wherein the casing comprises a tool portion for supporting the cutting unit and a lower end surface of the tool portion is higher than a lower end surface of the battery pack in a up and down direction.

12. An electric pipe cutter, comprising:
a casing comprising a support portion;
a cutting unit for cutting a target object;
a driving device for driving the cutting unit to move between a first position and a second position relative to the support portion; and
a transmission device for connecting the driving device to the cutting unit;
wherein the cutting unit is driven to perform a first motion in which the cutting unit moves from the second position to the first position and a second motion in which the cutting unit moves from the first position to the second position.

14. An electric pipe cutter, comprising:
an electric motor;
a casing comprising a support portion;
a cutting unit for cutting a target object and moving between a first position and a second position relative to the support portion of the casing under an action of the electric motor;
a main switch, wherein the main switch outputs a main switch state signal through a state of the main switch, controls the electric motor to perform forward rotation, and drives the cutting unit to perform a first motion in which the cutting unit moves from the second position to the first position; and
a toggle switch, wherein the toggle switch outputs a toggle switch state signal through a state of the toggle switch, controls the electric motor to perform reverse rotation, and drives the cutting unit to perform a second motion in which the cutting unit moves from the first position to the second position.

15. The electric pipe cutter of claim 14, further comprising:
a controller; and
a detection element for detecting a position of the cutting unit and outputting a detection signal to the controller;
wherein the controller determines or calculates input signals to control a rotation state of the electric motor and the input signals comprise at least the main switch state signal, the toggle switch state signal, and the detection signal.

16. The electric pipe cutter of claim 15, wherein different combinations of the input signals correspond to different special working conditions of the electric pipe cutter.

17. The electric pipe cutter of claim 16, wherein the special working conditions comprise at least a shutdown working condition, a braking working condition, or a speed regulation working condition.

18. The electric pipe cutter of claim 14, wherein a speed at which the cutting unit performs the second motion is greater than a speed at which the cutting unit performs the first motion.

19. The electric pipe cutter of claim 18, further comprising a transmission device connecting the cutting unit to the electric motor, wherein the transmission device comprises an output shaft connected to the electric motor, an output gear connected to the cutting unit, and a deceleration assembly connected to the output gear to the output shaft.

20. The electric pipe cutter of claim 14, further comprising a battery pack for powering the electric motor, wherein the electric motor is disposed in the casing, and the battery pack is disposed at a rear end of the casing and disposed at a lower side of the electric motor.
